(19) United States
(12) Patent Application Publication
(10) Pub. No.: US 2025/0070506 A1
(43) Pub. Date: Feb. 27, 2025

(54) CONNECTOR

(71) Applicant: BELLWETHER ELECTRONIC CORP., Taoyuan City (TW)

(72) Inventors: TAI-CHING SUNG, Taoyuan City (TW); YUNG-LIANG CHI, Taoyuan City (TW)

(21) Appl. No.: 18/806,151

(22) Filed: Aug. 15, 2024

Related U.S. Application Data
(63) Continuation-in-part of application No. 18/621,257, filed on Mar. 29, 2024.
(60) Provisional application No. 63/534,858, filed on Aug. 27, 2023.

(30) Foreign Application Priority Data
Jan. 31, 2024 (TW) 113103653
May 16, 2024 (TW) 113118050

(51) Int. Cl. H01R 13/631; H01R 13/50; H01R 13/52

(52) U.S. Cl. CPC H01R 13/631; H01R 13/50; H01R 13/5213

(57) ABSTRACT

A connector includes a connecting body, a cover case, an elastic arm, and a drawstring. The connecting body has a locking structure configured for engaging with a docking connector. The cover case is connected to the connecting body. One end of the elastic arm is connected to the cover case, and the elastic arm has a connection structure. A free end of the elastic arm is arranged at one side of the locking structure. One end of the drawstring is fixed to the connection structure, and another end of the drawstring passes through the cover case. When the drawstring is pulled in a direction away from the cover case, the drawstring moves the elastic arm through the connection structure to press the free end of the elastic arm, and another end of the locking structure is elastically deformed in a direction away from the docking connector.

### CROSS-REFERENCE TO RELATED PATENT APPLICATION

This application claims the benefit of priorities to Taiwan Patent Application No. 113103653, filed on Jan. 31, 2024, and No. 113118050, filed on May 16, 2024. The entire content of the above identified application is incorporated herein by reference.

This application claims the benefit of priority to the U.S. Provisional Patent Application Ser. No. 63/534,858, filed on Aug. 27, 2023, which application is incorporated herein by reference in its entirety. This application is a Continuation-In-Part of the U.S. application Ser. No. 18/621,257, filed on Mar. 29 2024 and entitled “CONNECTOR”, now pending.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a connector, and more particularly to a connector having a drawstring.

### BACKGROUND OF THE DISCLOSURE

In practice, a conventional cable connector is difficult to be removed from a docking connector when it is mated with the docking connector, especially when a size of the conventional cable connector is relatively small, or when a surrounding space of the conventional cable connector is insufficient to remove the cable connector.

### SUMMARY OF THE DISCLOSURE

In response to the above-referenced technical inadequacy, the present disclosure provides a connector for improving on the issues associated with the conventional cable connector and the docking connector that are difficult to be separated from each other after being mated with each other, especially when a size of the conventional cable connector is relatively small, or when a surrounding space of the conventional cable connector is insufficient.

In order to solve the above-mentioned problems, one of the technical aspects adopted by the present disclosure is to provide a connector configured for mating with a docking connector. The connector includes a connecting body, a cover case, and a drawstring. One end of the connecting body has a docking interface, one side of the connecting body has a locking structure, and the locking structure is configured to engage with a docking lock structure of the docking connector. One end of the cover case is connected to the connecting body, and the cover case further includes an elastic arm connected to a top portion of the cover case. One end of the drawstring is fixed to the connection structure, and another end of the drawstring passes through a wall hole of the cover case. When the drawstring is pulled in a direction away from the cover case, the drawstring moves the elastic arm, so that one end of the locking structure is pressed by the free end of the elastic arm, and another end of the locking structure is elastically deformed in a direction away from the docking lock structure.

Therefore, in the connector provided by the present disclosure, through a design of the connecting body, the cover case, the elastic arm, and the drawstring, a user can simply pull the drawstring, so that the connector can be conveniently, quickly, and easily separated from the docking connector. Hence, even if a size of the connector is relatively small or a surrounding space of the connector is insufficient, the connector can still be quickly separated from the docking connector by the user pulling the drawstring.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of a connector and a docking connector mated with each other according to a first embodiment of the present disclosure;

FIG. 2 is a schematic view of the connector and the docking connector separated from each other according to the first embodiment of the present disclosure;

FIG. 3 and FIG. 4 are schematic views of the connector from different angles of view according to the first embodiment of the present disclosure;

FIG. 5 is a schematic exploded view of the connector according to the first embodiment of the present disclosure;

FIG. 6 is a schematic partial cross-sectional view of a cover case and a drawstring of the connector according to the first embodiment of the present disclosure;

FIG. 7 is a schematic cross-sectional view taken along line VII-VII of FIG. 1;

FIG. 8 is a schematic cross-sectional view of the connector and the docking connector mated with each other when the drawstring is pulled according to the first embodiment of the present disclosure;

FIG. 9 is a schematic view of a connector and a docking connector mated with each other according to a second embodiment of the present disclosure;

FIG. 10 is a schematic view of the connector and the docking connector separated from each other according to the second embodiment of the present disclosure;

FIG. 11 and FIG. 12 are schematic views of the connector from different angles of view according to the second embodiment of the present disclosure;

FIG. 13 is a schematic cross-sectional view of the connector and the docking connector mated with each other according to the second embodiment of the present disclosure;

FIG. 14 is a schematic view of a connector and a docking connector mated with each other according to a third embodiment of the present disclosure;

FIG. 15 and FIG. 16 are schematic views of the connector from different angles of view according to the third embodiment of the present disclosure;

FIG. 17 is a schematic exploded view of an connecting body of the connector according to the third embodiment of the present disclosure;

FIG. 18 is a schematic partial sectional view of a cover and a drawstring of the connector according to the third embodiment of the present disclosure;

FIG. 19 is a schematic cross-sectional view taken along line XIX-XIX of FIG. 14;

FIG. 20 is a schematic view of a connector and a docking connector mated with each other according to a fourth embodiment of the present disclosure;

FIG. 21 is a schematic view of the connector according to the fourth embodiment of the present disclosure;

FIG. 22 is a partial sectional view of a cover and a drawstring of the connector according to the fourth embodiment of the present disclosure; and

FIG. 23 is a schematic cross-sectional view taken along line XXIII-XXIII of FIG. 20;

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

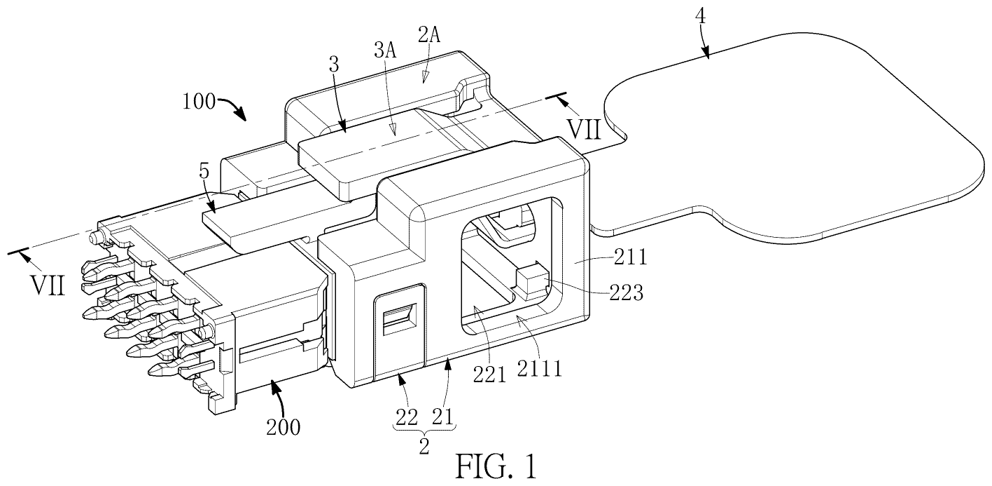

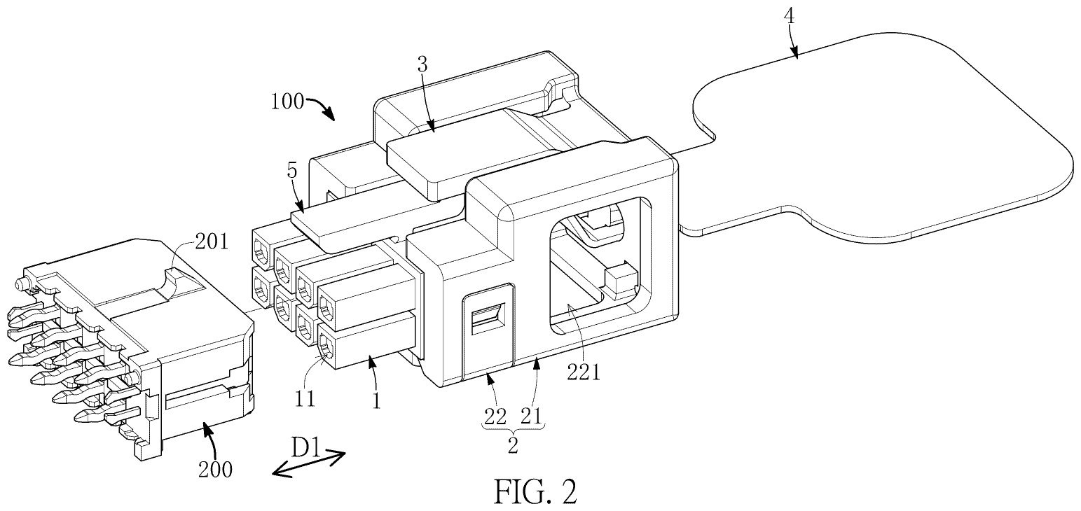

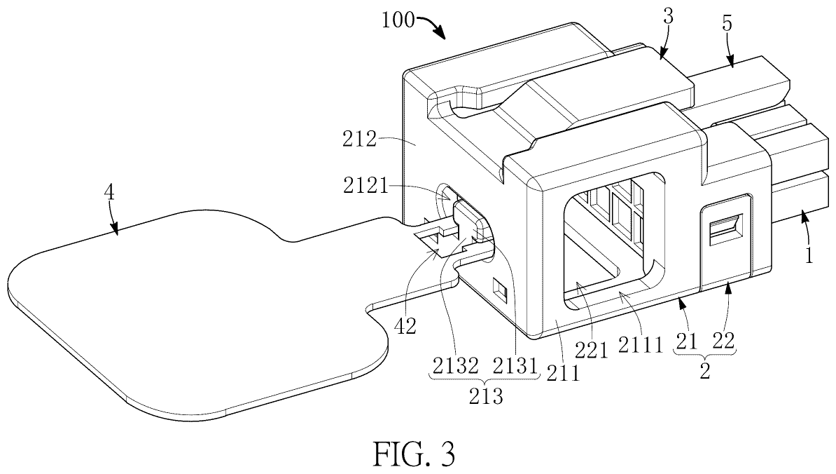

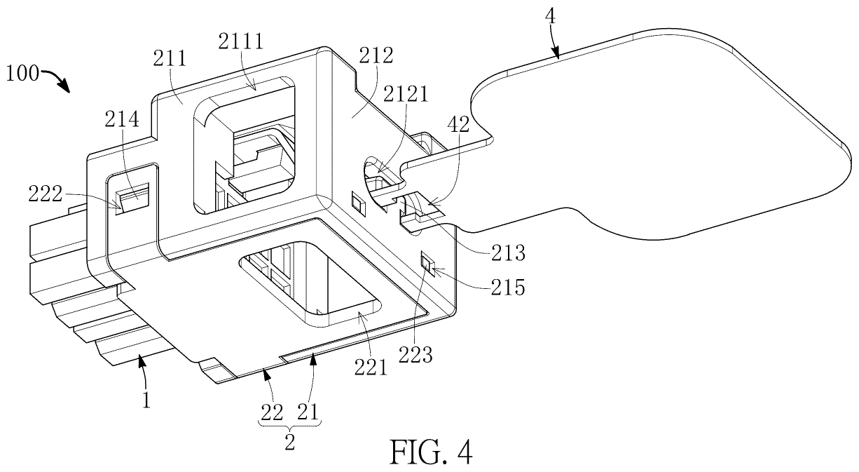

Referring to FIG. 1 to FIG. 6, a connector 100 of the present disclosure is configured to mate with (or insert into) a docking connector 200. The docking connector 200 includes a docking lock structure 201, and the connector 100 includes a connecting body 1, a cover case 2, an elastic arm 3, a drawstring 4, and a locking structure 5.

One end of the connecting body 1 has a docking interface, and the connecting body 1 is an insulating structure. In the present embodiment, the docking interface has a plurality of hollow tubular structures 11 that accommodate terminals therein. The connector 100 can mate with the docking connector 200 along a docking direction D1.

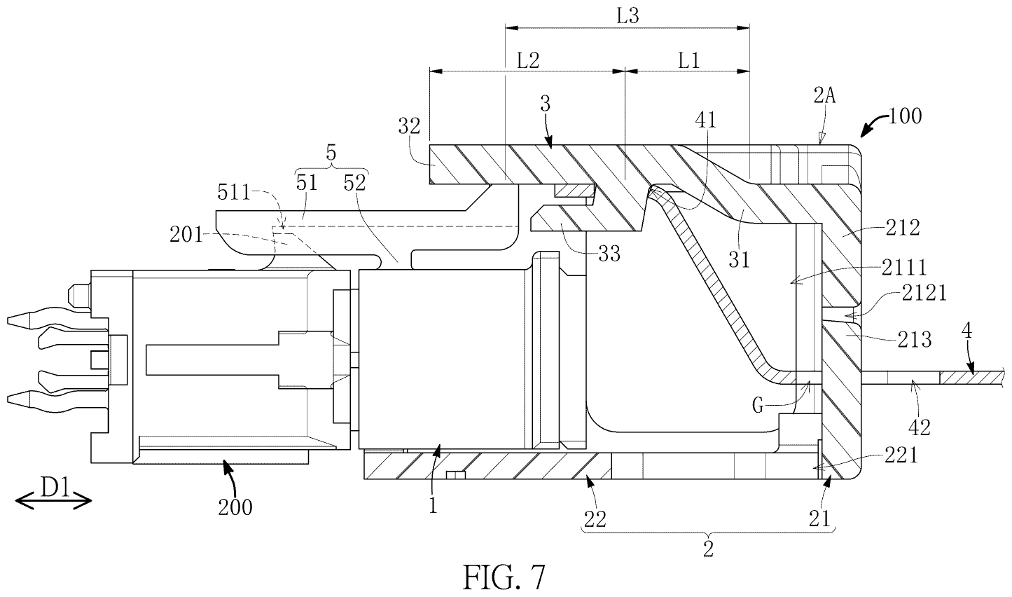

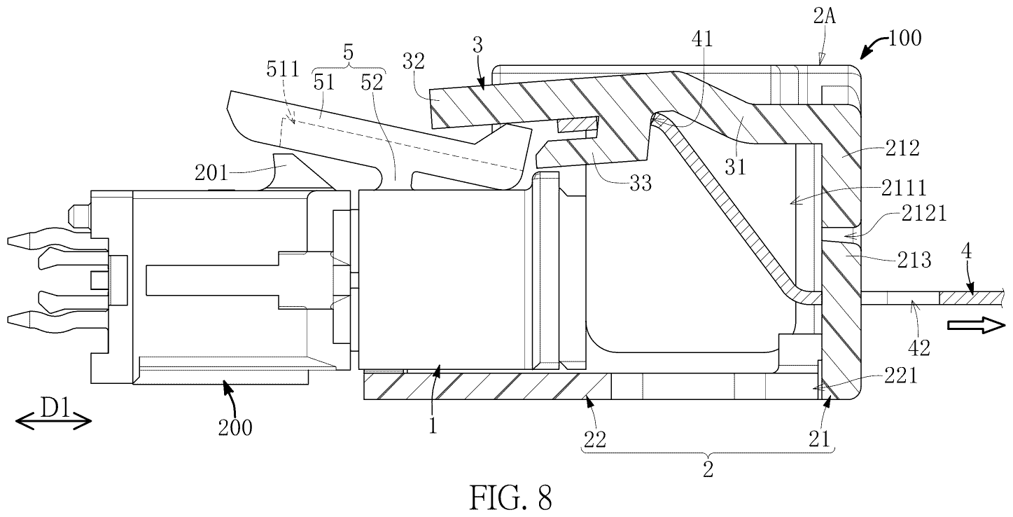

One side of the connecting body 1 has the locking structure 5. The locking structure 5 can be switched between a locked state (as shown in FIG. 7) and an unlocked state (as shown in FIG. 8) through receiving a force, so as to be deformed and either engaged with or separated from the docking lock structure 201 of the docking connector 200, respectively. In practice, the connecting body 1 and the locking structure 5 are integrally formed as a single one-piece structure.

The locking structure 5 includes an operation arm 51 and a supporting structure 52 (or two supporting structures 52), and the operation arm 51 is an elastic sheet-like structure. A middle portion of the operation arm 51 is connected to the connecting body 1 through the supporting structure 52, and one end of the locking structure 5 can be pressed to elastically deform in a direction toward the connecting body 1. When the one end of the locking structure 5 is pressed so as to elastically deform in the direction toward the connecting body 1, another end of the locking structure 5 can be elastically deformed in a direction away from the connecting body 1. In another embodiment, the locking structure 5 can be fixed (or connected) to the connecting body 1 through more than one supporting structure 52 to strengthen a fixation between the locking structure 5 and the connecting body 1. In another embodiment, the locking structure 5 can be fixed (or connected) to the connecting body 1 through a single supporting structure 52.

An inner side of the operation arm 51 of the locking structure 5 facing the connecting body 1 has an engaging structure 511 that is a slot (or a protrusion), and the docking lock structure 201 is a protrusion (or a slot). The engaging structure 511 can be engaged with the docking lock structure 201, so that the connector 100 is engaged with the docking lock structure 201 of the docking connector 200 through the locking structure 5.

One end of the cover case 2 is connected to the connecting body 1, and the cover case 2 includes a body 21, a cover 22, and the elastic arm 3. The body 21 has a plurality of side walls 211 and a rear wall 212 connected with the side walls 211, and an opening 2111 (e.g., a wire hole 2111) is formed adjacent to the side walls for cables passing through. A top portion (one of the side walls 211) of the body 21 is connected to the elastic arm 3. In other words, one of the side walls 211 of the body 21 can be provided with the elastic arm 3, the elastic arm 3 has a connection structure 33 configured for a drawstring being wrapped with, and another one of the side walls configured for the cables passing through. The cover 22 is detachably disposed on another side of the body 21 and adjacent to the opening 2111. The body 21 and the elastic arm 3 can be integrally formed as a single one-piece structure. Each of two side walls 211 of the body 21 can have at least one wire hole 2111, and the at least one wire hole 2111 is configured to provide for a plurality of cables (that are not shown in the figures) connected to the terminals of the connecting body 1 of the connector 100 to pass through the cover case 2. In the present embodiment, the two side walls 211 of the body 21 and the cover 22 are each provided with the wire hole, but a quantity of the wire hole 2111 of the body 21 and a position of the wire hole 2111 arranged on body 21 can be adjusted according to actual requirements.

Through a design of the cover 22 that is detachably connected to the body 21 (i.e., the cover 22 is detachably disposed on the body 21), the connection body 1 can be easily repaired or replaced by an user. The cover 22 is detachably fixed to the body 21 on one side of the cover case 2 that the drawstring 4 does not pass through (or that is different from the side having a wall hole.). The body 21, the elastic arm 3, and the connection structure 33 are integrally formed as a single one-piece structure. In addition, when the user replace, repair, or assemble the connection body 1, the fixed drawstring 4 and the elastic arm 3 will not be affected through a design of the elastic arm 3 and the connection structure 33 being disposed on the body 21, one end of the drawstring 4 being fixed to the connection structure 33, and another end of the drawstring 4 passing through the body 21 through a wall hole 2121 of a rear wall 212. Specifically, the wall hole 2121 formed on the rear wall 212 configured for the drawstring 4 passing through.

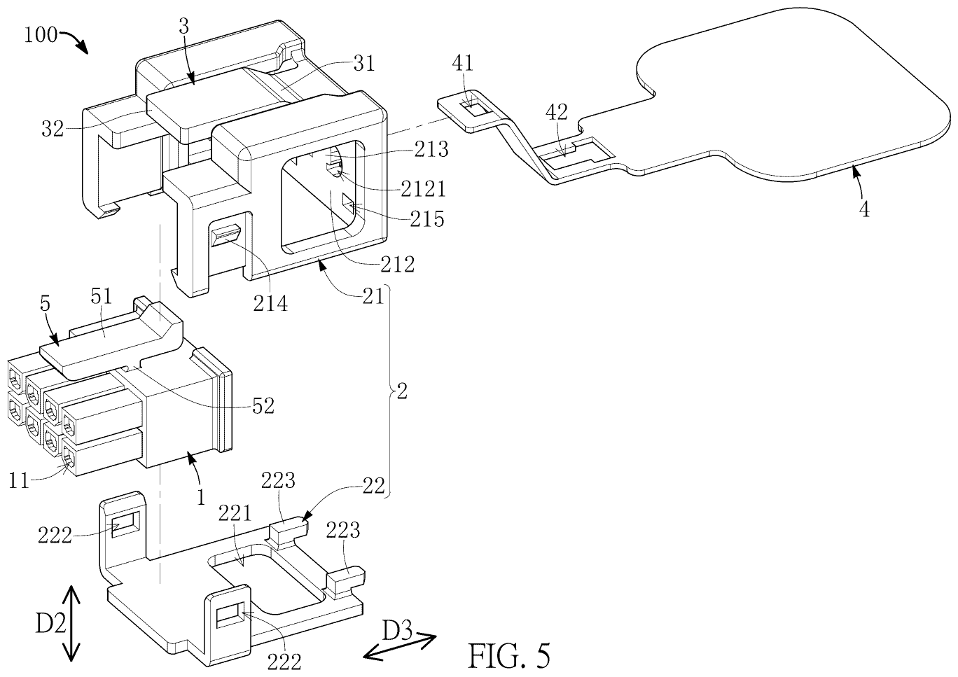

As shown in FIG. 5, the cover 22 includes two first connection structures 222 (e.g., through holes or protrusions) and two second connection structures 223 (e.g., protrusions or through holes). The two first connection structures 222 are engaged with two first engaging structures 214 (e.g., protrusions or through holes) of the body 21 on the two side walls 211 of the body 21, and the two second connection structures 223 are engaged with two second engaging structures 215 (e.g., through holes or protrusions) of the body 21 on the rear wall 212 thereof.

The cover 22 has a wire hole 221, and the wire hole 221 of the cover 22 is configured to provide for at least one of the cables connected to the terminals of the connecting body 1 to pass through the cover case 2.

Accordingly, the user can allow the cables connected to connector 100 to pass through the cover case 2 in different directions according to actual outgoing line requirements through a design of the body 21 and the cover 22 that have the wire hole 2111 and the wire hole 221, respectively.

Two ends of the elastic arm 3 are respectively a connection end 31 and a free end 32. The connection end 31 of the elastic arm 3 is connected to the body 21 of the cover case 2. The elastic arm 3 can be elastically deformed relative to the body 21 by a force. An inner surface of (the free end 32 of) the elastic arm 3 has the connection structure 33, and the connection structure 33 is an L-shaped structure. The free end 32 of the elastic arm 3 is arranged above the locking structure 5.

The one end of the drawstring 4 has a first through hole 41, and the drawstring 4 can be wrapped at the connection structure 33 through the first through hole 41 so as to be fixed to the connection structure 33. Another end of the drawstring 4 passes through the wall hole 2121 of the rear wall 212. When the drawstring 4 is pulled, the one end of the drawstring 4 connected to the connection structure 33 can drive the free end 32 of the elastic arm 3 to elastically deform in an inward direction.

As shown in FIG. 7 and FIG. 8, when the drawstring 4 is pulled, the one end of the drawstring 4 wrapped at the connection structure 33 can drive the free end 32 of the elastic arm 3 to press the one end of the locking structure 5, so that the another end of the locking structure 5 is elastically deformed. Accordingly, the connector 100 can be unlocked from the docking connector 200.

After the locking structure 5 of the connector 100 is unlocked from the docking lock structure 201, the connector 100 is separated from the docking connector 200 through use of the drawstring 4. Naturally, the user can hold the connector 100 and directly remove the connector 100 from the docking connector 200.

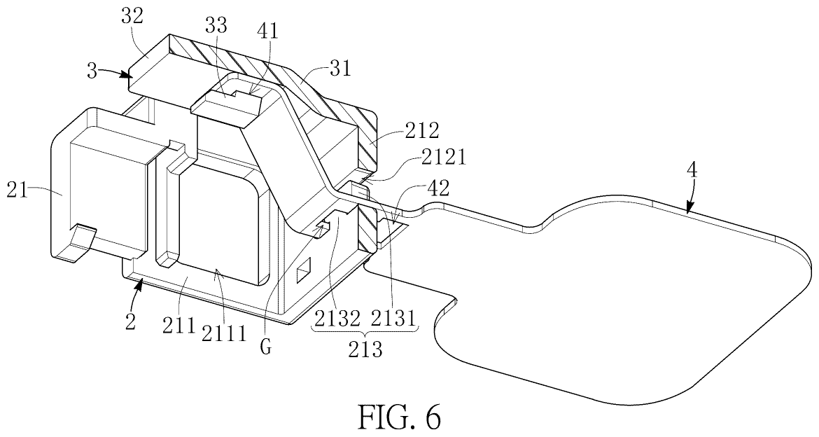

As shown in FIG. 6 and FIG. 7, the rear wall 212 of the body 21 has a limiting structure 213, and the limiting structure 213 is arranged in the wall hole 2121. The limiting structure 213 includes a head portion 2131 and a neck portion 2132, a width of the head portion 2131 is greater than a width of the neck portion 2132, the head portion 2131 is connected to one end of the neck portion 2132 to jointly form the limiting structure 213, and another end of the neck portion 2132 is connected to the rear wall 212. The second through hole 42 has a first portion, having a first width, for guiding a movement of the drawstring 4 when being pulled, and a second portion, having a second width larger than the first width, for installing the limiting structure 213 into the second through hole 42 of the drawstring 4. The first portion is disposed on a front end of the second through hole 42 and the second portion is disposed on a rear end thereof. A width of the head portion 2131 is roughly greater than a first width, but smaller than the second width of the second through hole 42 of the drawstring 4. A width of the neck portion 2132 is less than the first width of the second through hole 42.

The limiting structure 213 is configured to limit a movable range of the drawstring 4 in the wall hole 2121. More specifically, when the second through hole 42 of the drawstring 4 is wrapped at the limiting structure 213 and the drawstring 4 is pulled, the head portion 2131 can limit the drawstring 4 to prevent the drawstring 4 from being separated from the wall hole 2121.

As shown in FIG. 6 and FIG. 7, when the drawstring 4 is not pulled and an inner surface of the first through hole 41 of the drawstring 4 abuts against the connection structure 33, an inner surface of the second through hole 42 of the drawstring 4 and the limiting structure 213 have a gap G along a pulling direction of the drawstring 4.

As shown in FIG. 7 and FIG. 8, when the drawstring 4 is pulled to drive the elastic arm 3 to press the locking structure 5, an inner surface of the second through hole 42 of the drawstring 4 abuts against the limiting structure 213 to protect the elastic arm 3 from being excessively deformed. At this time, if the drawstring 4 is continuously pulled, the inner surface of the first through hole 41 and the inner surface of the second through hole 42 of the drawstring 4 can jointly drive the connector 100 to separate from the docking connector 200.

As shown in FIG. 7, when the locking structure 5 of the connector 100 is engaged with the docking lock structure 201 of the docking connector 200 and the user pulls the drawstring 4 to move along a rightward direction shown in FIG. 7, the one end of the drawstring 4 having the first through hole 41 can drive the elastic arm 3 downward to press the locking structure 5 through the connection structure 33, so that the locking structure 5 is no longer engaged with the docking lock structure 201. Lastly, the user can continuously pull the drawstring 4 to drive the connector 100 to separate from the docking connector 200.

Accordingly, through a design of the second through hole 42 of the drawstring 4 that is wrapped at the limiting structure 213 and a design of the gap G, the user can directly and continuously pull on the drawstring 4, so that the connector 100 can be unlocked and separated from the docking connector 200.

As shown in FIG. 7, a linear distance L1 between a position of the connection structure 33 connected to the elastic arm 3 and the connection end 31 of the elastic arm 3 is less than a linear distance L2 between the position of the connection structure 33 connected to the elastic arm 33 and the free end 32. That is to say, the connection structure 33 is arranged adjacent to the connection end 31 of the elastic arm 3. Accordingly, the user can drive the elastic arm 3 to press the locking structure 5 by a relatively small moving distance. In addition, in one embodiment where an overall height of the cover case 2 is greater than 7 mm, a linear distance L3 between a position of the elastic arm 3 configured for pressing the locking structure 5 and a position of the elastic arm 3 connected to the cover case 2 is within a range from 7 mm to 20 mm.

Further referring to FIG. 1, an outer lateral surface 3A of the elastic arm 3 is flush with an outer lateral surface 2A of the body 21 (or the top wall of the cover case 2), and an area of the at least one wire hole 2111 of the at least one side wall 211 of the body 21 is within a range from 65% to 90% of a total area of the at least one side wall 211. Accordingly, the cables connected to the connecting body 1 can preferably pass through the cover case 2 via the at least one wire hole 2111.

### Second Embodiment

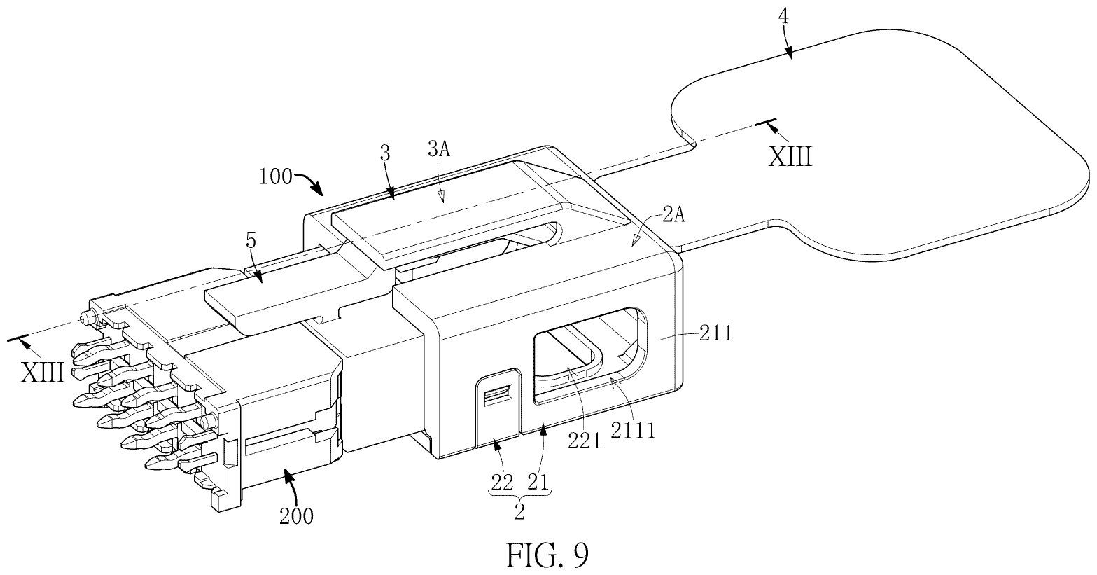

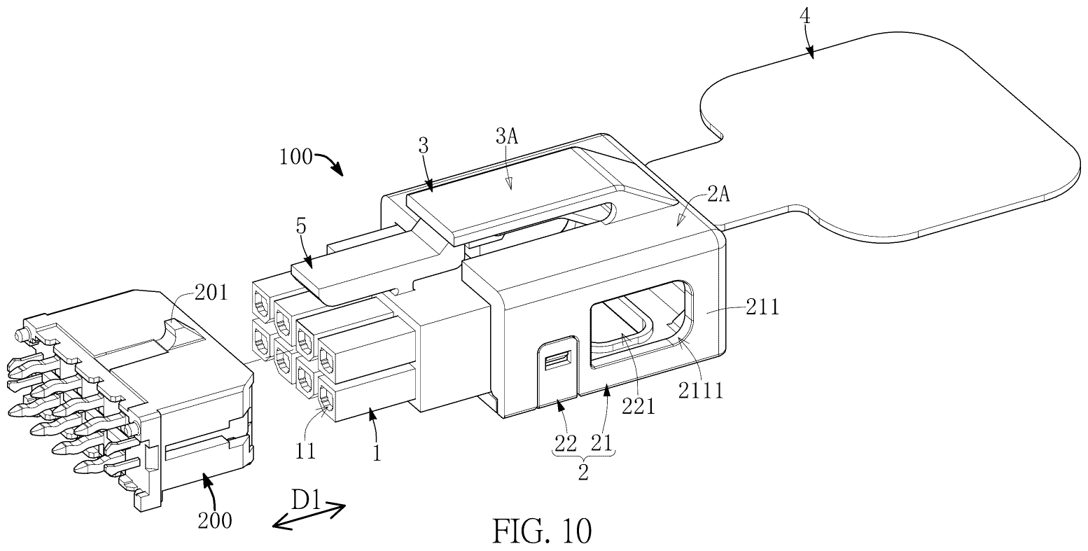

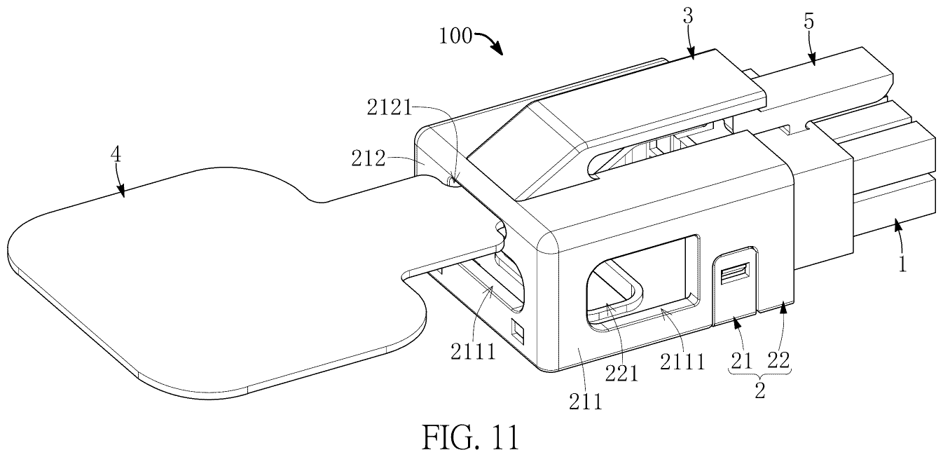

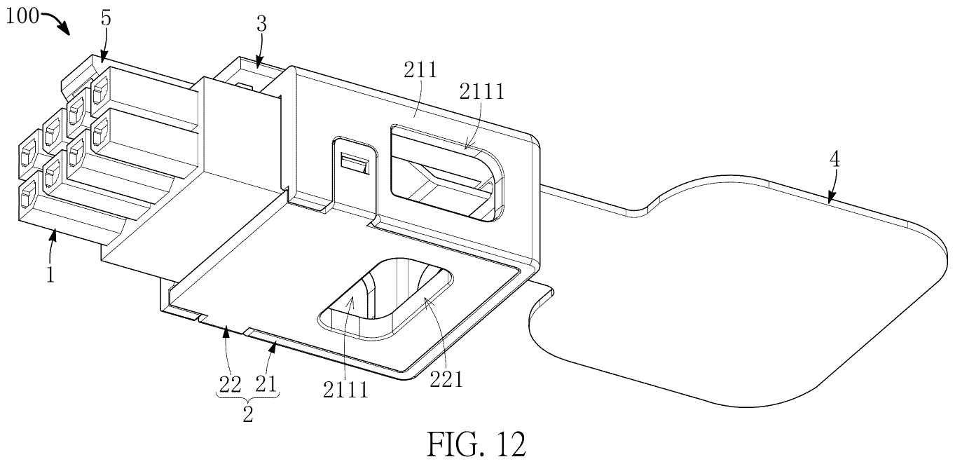

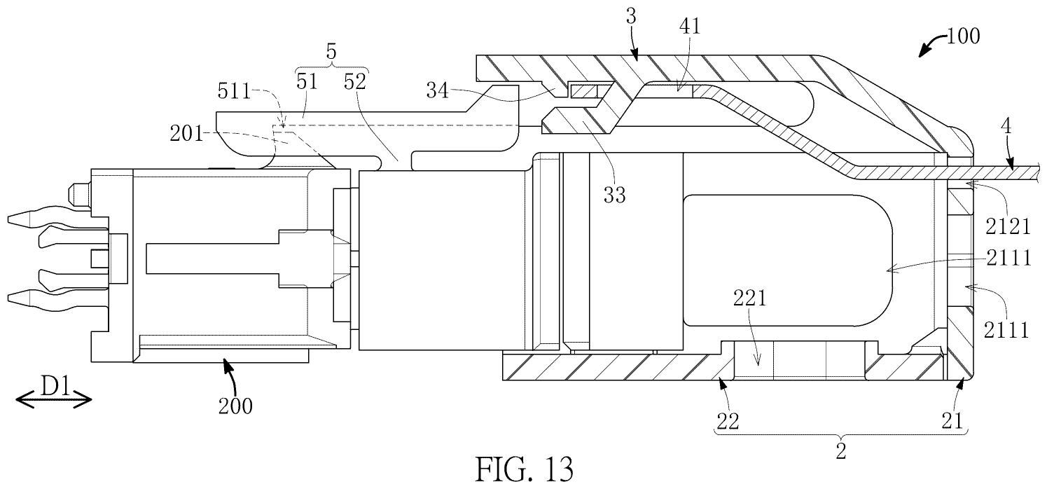

Referring to FIG. 9 to FIG. 13, one of differences between the present embodiment and the aforementioned embodiment is described as follows. The outer lateral surface 3A of the elastic arm 3 protrudes from an outer lateral surface 2A of the cover case 2; that is, the outer lateral surface 3A of the elastic arm 3 is not flush with (e.g., protrudes from) the outer lateral surface 2A of the cover case 2. An inner side of the elastic arm 3 further includes a stop structure 34 disposed at a front of and adjacent to the connection structure 33, and the stop structure 34 is configured to limit a movable range of the drawstring 4 fixed to the connection structure 33 so as to prevent the drawstring 4 from being separated from the connection structure 33. Another one of the differences between the present embodiment and the aforementioned embodiment is that the wall hole 2121 of the of the rear wall 212 of the cover case 2 is arranged adjacent to a side of the cover case 2 connected to the elastic arm 3, and the wall hole 2121 of the cover case 2 does not have the limiting structure 213.

### Third Embodiment

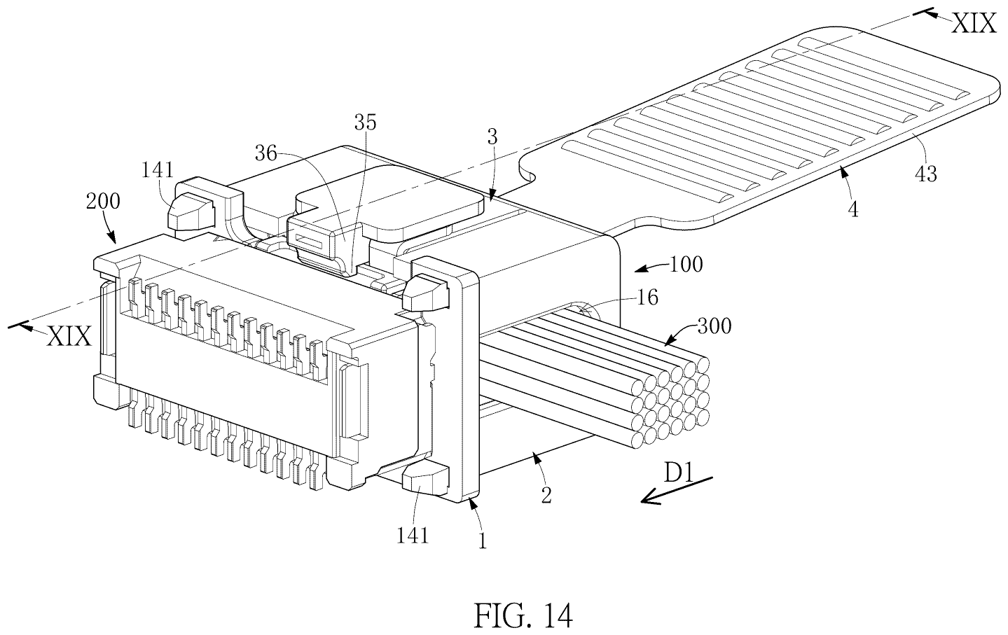

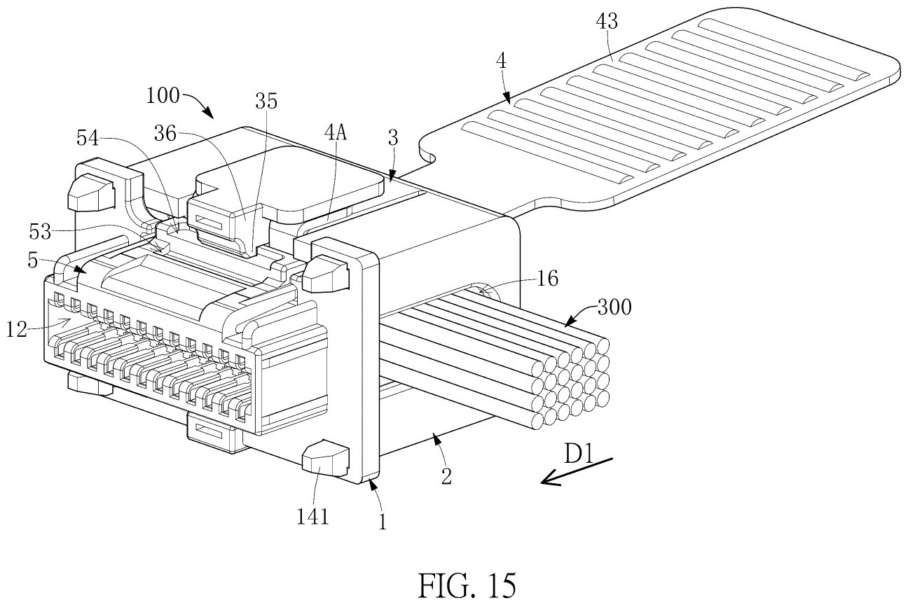

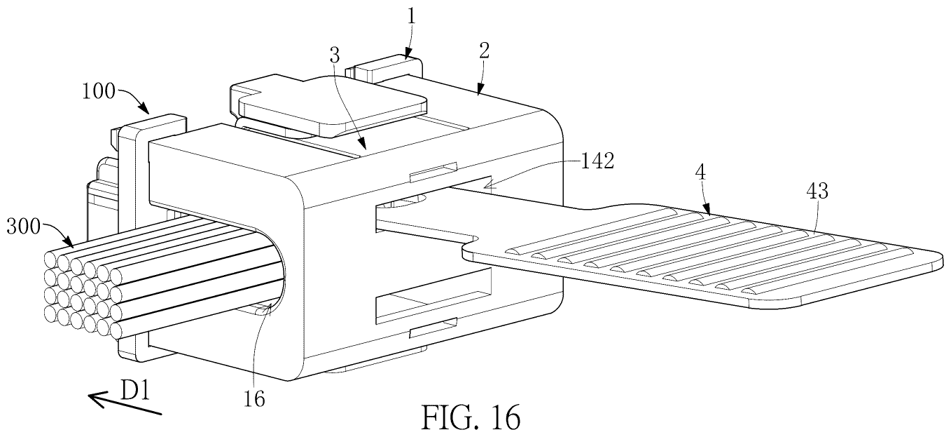

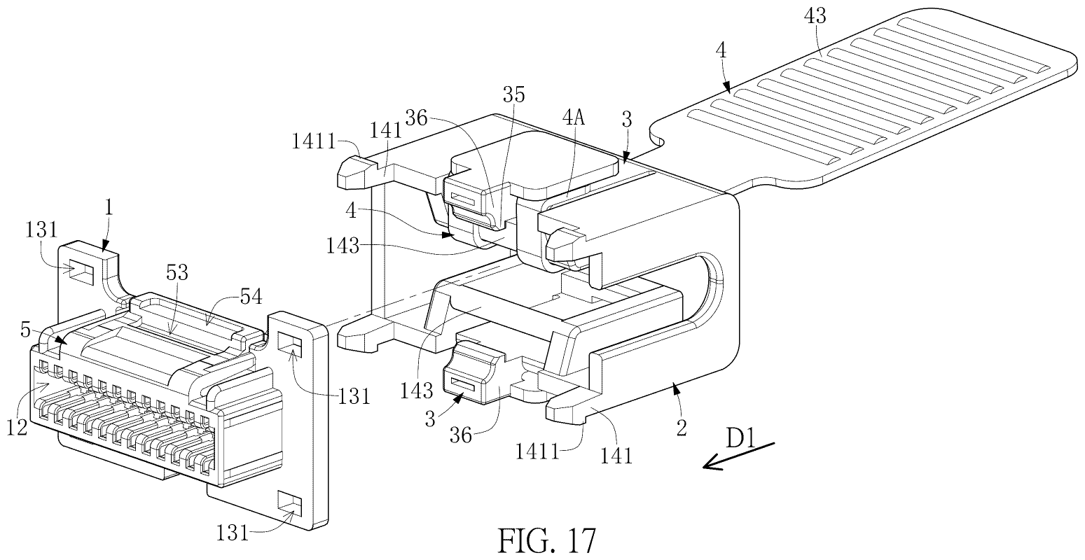

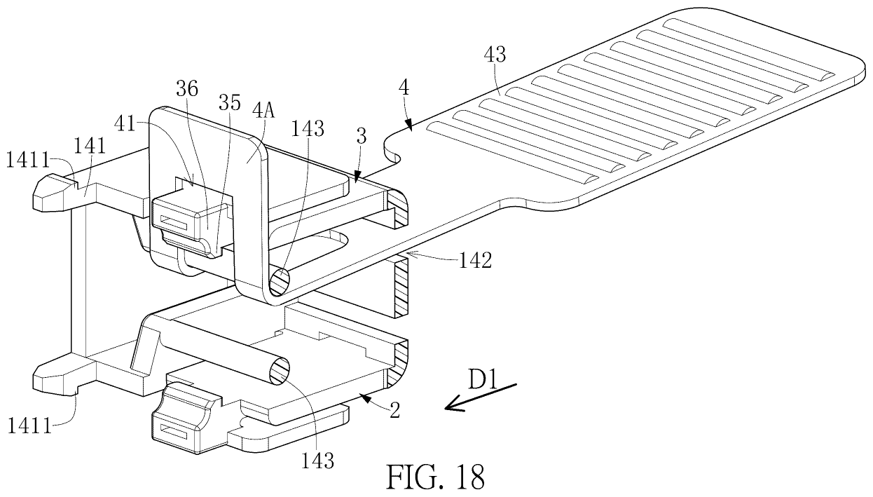

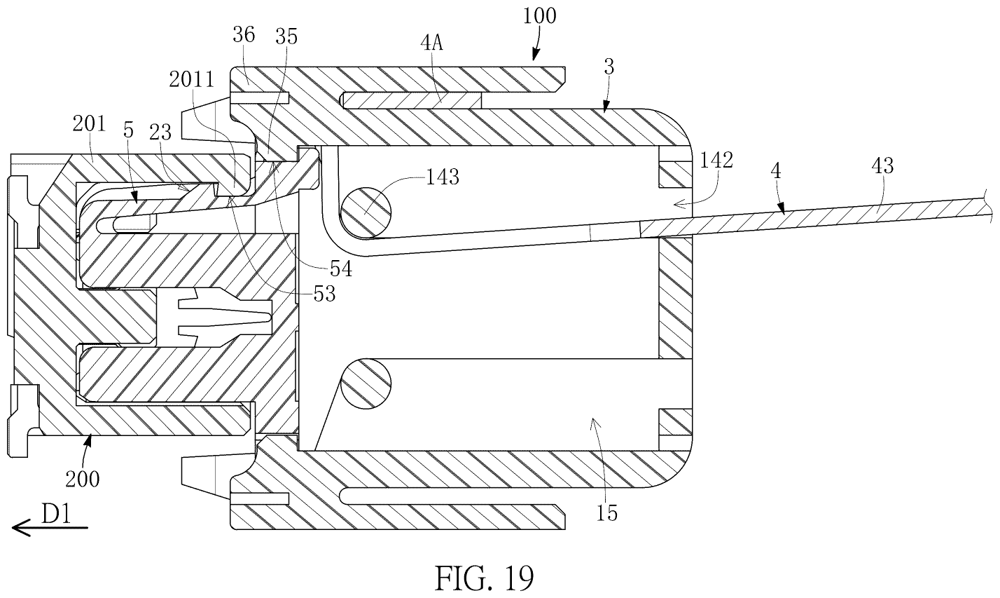

Referring to FIG. 14 to FIG. 19, FIG. 14 is a schematic view of a connector and a docking connector mated with each other according to a third embodiment of the present disclosure, FIG. 15 and FIG. 16 are schematic views of the connector from different angles of view according to the third embodiment of the present disclosure, FIG. 17 is a schematic exploded view of a connecting body of the connector according to the third embodiment of the present disclosure, FIG. 18 is a schematic partial sectional view of a cover and a drawstring of the connector according to the third embodiment of the present disclosure, and FIG. 19 is a schematic cross-sectional view taken along line XIX-XIX of FIG. 14.

The present embodiment provides a connector 100, which includes a connecting body 1, a lock structure 5, at least one elastic arm 3 (e.g., one elastic arm or two elastic arms 3), and a drawstring 4. The connector 100 is configured to mate with (or insert into) a docking connector 200.

One end of the connecting body 1 has a docking interface. In the present embodiment, the docking interface has an insertion slot 12 provided with at least one conductive component arranged therein. In the present embodiment, a quantity of the at least one conductive component of the insertion slot 12 can be multiple. When the connector 100 and the docking connector 200 are mated (or inserted) with each other along a docking direction D1, the conductive components of the insertion slot 12 are respectively mated (or inserted) with a plurality of conductive components of the docking connector 200.

In practice, the connector 100 includes the connecting body 1 and a cover case 2. One end of the connecting body 1 has the docking interface, and another end of the connecting body 1 is connected to the cover case 2. The connecting body 1 and the cover case 2 jointly define an accommodating space 15, the conductive components of the insertion slot 12 are connected to a plurality of cables 300, and a part of each of the cables 300 is arranged in the accommodating space 15. At least one side of the cover case 2 has an outlet opening 16, and the cables 300 pass through the connecting body 1 through the outlet opening 16. A quantity of the outlet opening 16 and a position of the outlet opening 16 formed on the cover case 2 can be designed according to requirements. For example, the outlet opening 16 can be arranged in a left side, a right side, a back side, or a lower side of the cover case 2.

The another end of the connecting body 1 and one end of the cover case 2 respectively include a plurality of first engaging structures 131 and a plurality of second engaging structures 141, and the connecting body 1 is detachably fixed to the cover case 2 through the first engaging structures 131 and the second engaging structures 141. Each of the first engaging structures 131 may be a through hole, and each of the second engaging structures 141 may be an elastic arm structure. After the elastic arm structure passes through the through hole, a protrusion 1411 arranged on a tail end of the elastic arm structure is engaged with a side of the through hole.

The lock structure 5 is arranged at one side of the connecting body 1, and the lock structure 5 can be switched between a locked mode and an unlocked mode by a force so as to be engaged with or separated from a docking lock structure 201 of the docking connector 200. The lock structure 5 can be an elastic sheet-like structure, one end of the elastic sheet-like structure is a fixed end that is connected to the connecting body 1 and another end of the elastic sheet-like structure is a free end. Moreover, a side of the free end of the elastic sheet-like structure has a first engaging portion 53, and the first engaging portion 53 can be a slot (or a protrusion). The free end of the lock structure 5 can further have an engage slot 54, and the first engaging portion 53 is closer to the fixed end of the lock structure 5 than the engage slot 54. In another embodiment, a middle portion of the lock structure 5 may be connected to the connecting body 1 and two ends are free ends, one end having an engaging portion and the other end having an operation portion for be switched between a locked mode and an unlocked mode.

As shown in FIG. 19, when the connector 100 and the docking connector 200 are mated (or inserted) with each other, a second engaging portion 2011 of the docking lock structure 201 of the docking connector 200 is correspondingly engaged with the first engaging portion 53, and the engage slot 54 is exposed from the docking connector 200. The second engaging portion 2011 can be a protrusion (or a slot), so that the second engaging portion 2011 can be correspondingly engaged with the slot (or the protrusion) of the first engaging portion 53.

As shown in FIG. 17 and FIG. 19, one end of the elastic arm 3 is connected to the connecting body 1, and another end of the elastic arm 3 is a free end. The elastic arm 3 can be elastically deformed relative to the connecting body 1 by an external force. The free end of the elastic arm 3 is arranged adjacent to the free end of the lock structure 5. The free end of the elastic arm 3 can have an engaging structure 35. When the cover case 2 and the connecting body 1 are connected to each other, the engaging structure 35 of the elastic arm 3 is engaged with the engage slot 54 of the lock structure 5.

As shown in FIG. 17 to FIG. 19, one end of the drawstring 4 has a through part 4A, the through part 4A has the first through hole 41, the elastic arm 3 is enclosed by the through part 4A, and another end of the drawstring 4 is exposed from the connecting body 1 by passing through a through hole (wall hole) 142 of the cover case 2. In other words, the through part 4A can be referred as an end segment 4A of the drawstring 4. In practice, an outer side of the elastic arm 3 can include a fixing structure 36, an inner side of the cover case 2 includes at least one supporting element 143 (e.g., one supporting element 143 or two supporting elements 143), and the supporting element 143 is arranged adjacent to the free end of the elastic arm 3. The fixing structure 36 is fixed to the elastic arm 3, two ends of the supporting element 143 are fixed to the cover case 2, and the supporting element 143 is not directly connected to the elastic arm 3. The fixing structure 36 is wrapped around the through part 4A (e.g., the end segment 4A) along a penetrating axis of the first through hole 41, and the penetrating axis is perpendicular to the docking direction D1 of the connector 100. In other words, the through part 4A is a ring-shaped structure, and the through part 4A has the first through hole 41 penetrating through two surfaces of the drawstring 4. When a structure passes through the ring-shaped structure through the through hole along an axial direction, the axial direction is defined as the penetrating axis.

In an installation manner of the drawstring 4, the fixing structure 36 is wrapped around the through part 4A (e.g., the end segment 4A) of the drawstring 4 that is arranged adjacent to an outer side of elastic arm 3, so that the fixing structure 36 is strapped with the one end of the drawstring 4. Then, the another end of the drawstring 4 is exposed from the cover case 2 after being winded around the supporting element 143 and passing through the through hole 142 of the cover case 2 to change a pulling direction of the drawstring 4. In practice, the drawstring 4 can have a hold portion 43 arranged away from one end thereof engaged with the fixing structure 36, and the hold portion 43 has an anti-slip structure (e.g., ribs or a rough surface) or a wider gripping surface to facilitate the user's grip.

It should be noted that, as shown in FIG. 17 of the present embodiment, the cover case 2 has two elastic arms 3 and two supporting elements 143 that are respectively arranged on two opposite sides of the cover case 2, so that the user can easily rotate the cover case 2 by 180 degrees to be fixed to the connecting body 1, thereby switching a position of the outlet opening 16 and changing an outgoing line direction of the cables 300. In other embodiments, the cover case 2 can only include one elastic arm 3 and one supporting element 143.

As shown in FIG. 19, during the process implemented for mating (or inserting) the connector 100 and the docking connector 200 with each other, the docking lock structure 201 of the docking connector 200 passes a guide inclined plane 23 of the lock structure 5 and engages with the first engaging portion 53. Accordingly, the lock structure 5 is in the locked mode, and the connector 100 can be firmly mated with (or inserted into) the docking connector 200.

Accordingly, as shown in FIG. 19, when the connector 100 and the docking connector 200 are mated with each other, and the drawstring 4 is pulled in a direction away from the connecting body 1, the elastic arm 3 is moved by the drawstring 4 so as to press the free end of the lock structure 5, thereby separating the first engaging portion 53 of the lock structure 5 from the second engaging portion 2011 of the docking lock structure 201. That is to say, pulling the drawstring 4 makes the lock structure 5 to be in the unlocked mode, and then the connector 100 can be separated from the docking connector 200 along with the pulling of the drawstring 4.

In summary, in the present disclosure, through the cooperation of the elastic arm 3, the drawstring 4, and the lock structure 5, etc. of the connector 100, the user can quickly and simply separate the connector 100, which is fixed to the docking connector 200 through the lock structure 5, from the docking connector 200 by pulling the drawstring 4.

### Fourth Embodiment

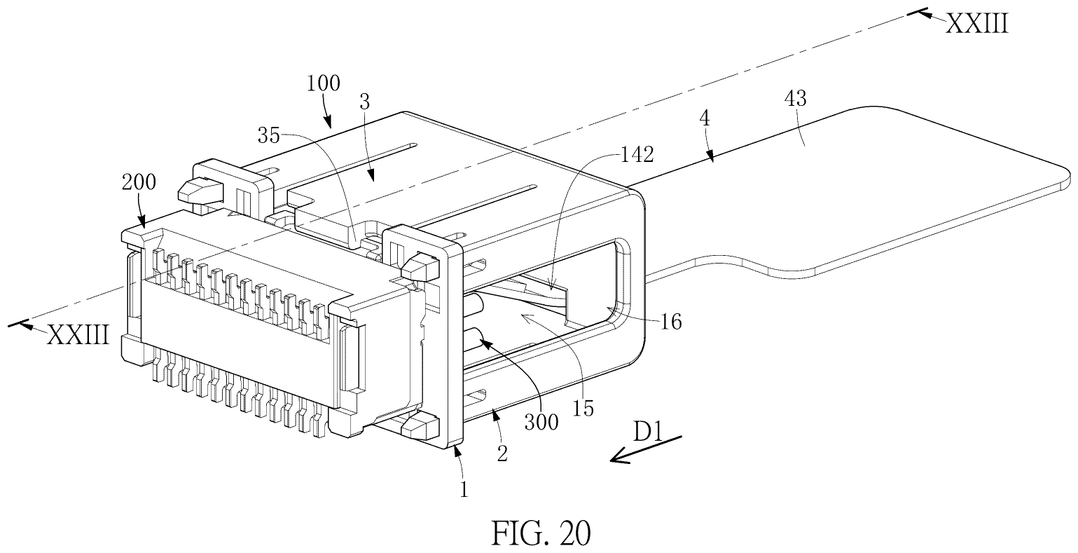

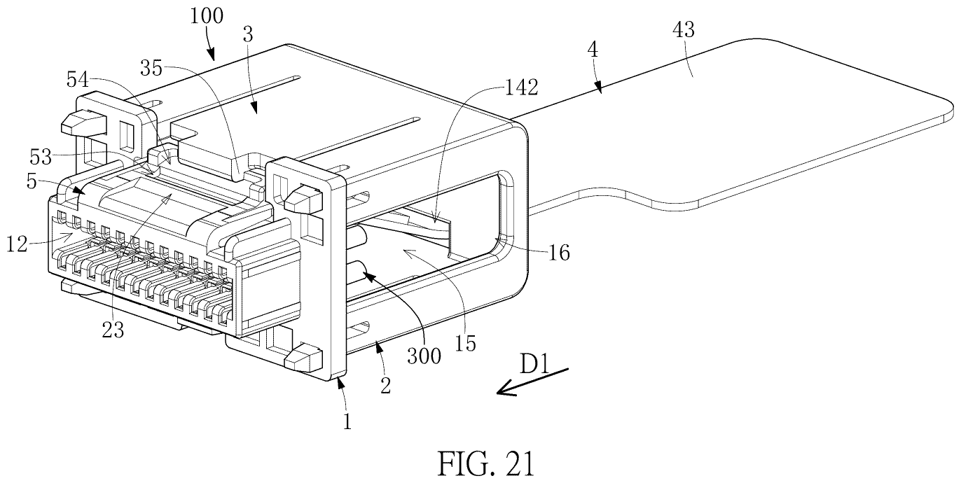

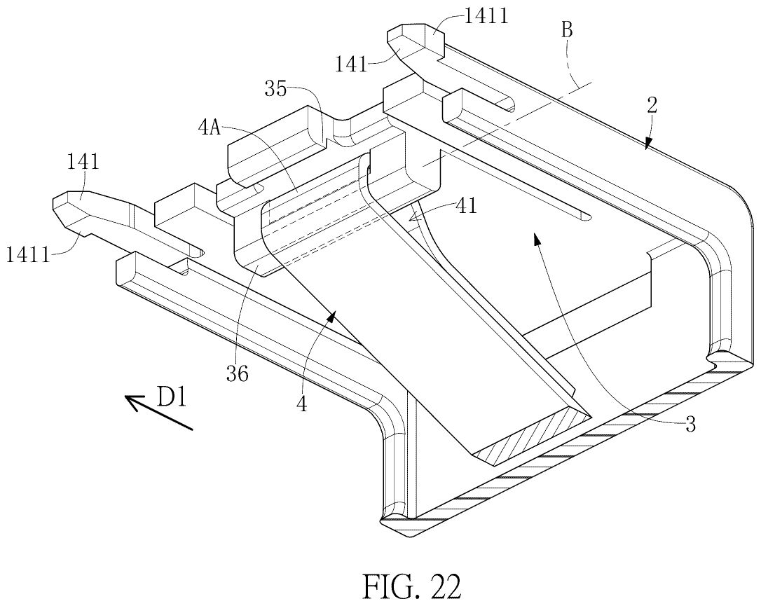

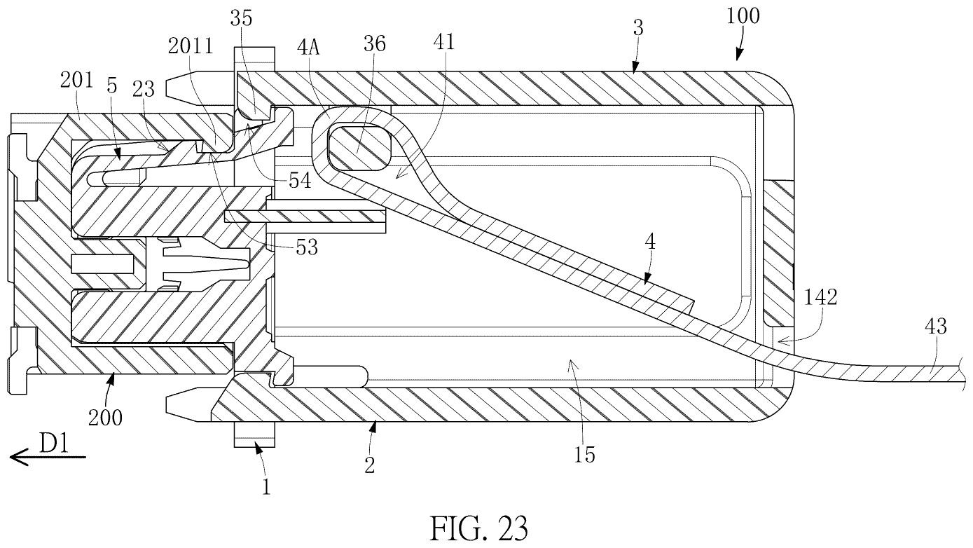

Referring to FIG. 20 to FIG. 23, FIG. 20 is a schematic view of a connector and a docking connector mated with each other according to a fourth embodiment of the present disclosure, FIG. 21 is a schematic view of the connector according to the fourth embodiment of the present disclosure, FIG. 22 is a schematic partial sectional view of a cover and a drawstring of the connector according to the fourth embodiment of the present disclosure, and FIG. 23 is a schematic cross-sectional view taken along line XXIII-XXIII of FIG. 20.

A description of the connecting body 1 of the connecting body 1 of the present embodiment is same as the aforementioned description of the connecting body 1 of the third embodiment, and would not be further described herein for the sake of brevity. A difference between the present embodiment and the aforementioned third embodiment is that the fixing structure 36 is disposed on an inner side of the elastic arm 3, one end of the drawstring 4 has the through part 4A and the first through hole 41, the through part 4A is directly fixed to the fixing structure 36, and another end of the drawstring 4 is exposed from the connecting body 1 (and the cover case 2) by passing through the through hole 142 of the cover case 2. The fixing structure 36 is disposed in the first through hole 41 along a penetrating axis B of the first through hole 41, and the penetrating axis B is perpendicular to the docking direction D1 of the connector 100. The elastic arm 3 is disposed at one side of the cover case 2 and an outer surface of the elastic arm 3 and aside surface of the cover case 2 are aligned with each other. The through hole 142 is arranged on another one side of the cover case 2, and the through hole 142 is arranged on an area of the connecting body 1 that is away from the fixing structure 36. For example, as shown in FIG. 23, the elastic arm 3 and the through hole 142 are arranged on two opposite sides or two opposite corners of the cover case 2, and the elastic arm 3 and the through hole 142 are approximately arranged at a front end and a rear end of the cover case 2, respectively. In other words, as shown in FIG. 23, the elastic arm 3 and the through hole 142 are respectively arranged adjacent to two ends along a diagonal line of the cover case 2. Naturally, in other embodiments, the elastic arm 3 and the through hole 142 may be disposed adjacent to the front end and the rear end of one side of the cover case 2.

As shown in FIG. 23, when the drawstring 4 is pulled in a direction away from the cover case 2, the fixing structure 36 and the elastic arm 3 are moved by pulling the drawstring 4 so as to press the lock structure 5, thereby enabling the lock structure 5 to be separated from the docking lock structure 201 of the docking connector 200.

### Beneficial Effects of the Embodiment

In conclusion, in the connector provided by the present disclosure, the user can easily and quickly unlock and separate the connector 100 from the docking connector 200 by pulling the drawstring 4.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A connector configured for mating with a docking connector, the connector comprising:
a connecting body, wherein one end of the connecting body has a docking interface, one side of the connecting body has a locking structure, and the locking structure is configured to engage with a docking lock structure of the docking connector;
a cover case, wherein one end of the cover case is connected to the connecting body, and the cover case further includes an elastic arm connected to a top portion of the cover case; and
a drawstring, wherein one end of the drawstring is fixed to the elastic arm, and another end of the drawstring passes through a wall hole of the cover case;
wherein, when the drawstring is pulled in a direction away from the cover case, the drawstring moves the elastic arm, so that one end of the locking structure is pressed by the free end of the elastic arm, and another end of the locking structure is elastically deformed in a direction away from the docking lock structure.

2. The connector according to claim 1, wherein an inner side of the free end of the elastic arm has a connection structure, the connection structure is arranged adjacent to the locking structure, and the end of the drawstring is fixed to the connection structure.

3. The connector according to claim 2, wherein two ends of the elastic arm are respectively a connection end and the free end, and wherein a linear distance between a position of the connection structure connected to the elastic arm and the connection end is less than a linear distance between the position of the connection structure connected to the elastic arm and the free end.

4. The connector according to claim 2, wherein an outer lateral surface of the elastic arm protrudes from an outer lateral surface of the cover case, and wherein an inner side of the elastic arm includes a stop structure, the stop structure is disposed adjacent to the connection structure, and the stop structure is configured to limit a movable range of the drawstring fixed to the connection structure.

5. The connector according to claim 1, wherein the cover case includes a body and a cover, one side of the body has the elastic arm, and the cover is detachably disposed on another side of the body, wherein at least one side wall of the cover case has at least one wire hole, and the at least one wire hole is configured to provide for a plurality of cables connected to terminals fixed in the connector to pass through the cover case, and wherein the cover is detachably fixed to one side of the body that is different from the side having the wall hole.

6. The connector according to claim 5, wherein the cover has at least one wire hole, and the at least one wire hole of the cover is configured to provide for at least one of the cables to pass through the cover case.

7. The connector according to claim 1, wherein a rear wall of the cover case connected to the connecting body has the wall hole.

8. The connector according to claim 7, wherein the rear wall of the cover case further includes a limiting structure, the limiting structure is arranged in the wall hole, the drawstring has a first through hole, the drawstring is wrapped at the limiting structure through the first through hole, and the limiting structure is configured to limit a movable range of the drawstring in the wall hole.

9. The connector according to claim 8, wherein a second through hole of the drawstring and the limiting structure has a gap along a pulling direction of the drawstring, and wherein, when the drawstring is pulled, an inner surface of the first through hole abuts against the limiting structure to move the connector in a direction away from the docking connector.

10. The connector according to claim 1, wherein an outer lateral surface of the elastic arm is flush with an outer lateral surface of the cover case.

11. The connector according to claim 1, wherein at least one side wall of the cover case has a wire hole, and an area of the at least one wire hole is within a range from 65% to 90% of a total area of the at least one side wall.

12. The connector according to claim 1, wherein a linear distance between a position of the elastic arm configured to abut against the locking structure and a position of the elastic arm connected to the cover case is within a range from 7 mm to 20 mm.

13. The connector according to claim 1, wherein the docking interface has a plurality of hollow tubular structures.

14. A cover case configured for connecting with one side of a connector and configured for allowing a plurality of cables to exit therefrom, the cover case comprising:
a body having a plurality of side walls and a rear wall connected with the side walls, and an opening is formed adjacent to the side walls for connected with the connector;
an elastic arm connected with one of the side walls of the body and having a connection structure configured for a drawstring being wrapped with;
at least one wire hole formed on another one of the side walls configured for the cables passing through; and
a wall hole formed on the rear wall configured for the drawstring passing through.

15. The cover case according to claim 14, wherein the connection structure is disposed on an inner surface of the elastic arm.

16. The cover case according to claim 14, wherein a stop structure disposed at a front of the connection structure for limiting a movable range of the drawstring.

17. The cover case according to claim 14, wherein the rear side has a limiting structure arranged in the wall hole, the limiting structure includes a head portion and a neck portion, and a width of the head portion is greater than a width of the neck portion.

18. The cover case according to claim 14, further comprising a supporting element configured for the drawstring passing through to change a pulling direction of the drawstring, wherein the supporting element is fixed to the cover case and arranged adjacent to the free end of the elastic arm.

19. The cover case according to claim 14, wherein an outer lateral surface of the elastic arm is flush with an outer lateral surface of the top wall of the cover case.

20. The cover case according to claim 14, further comprising a cover wherein the cover is detachably disposed on another side of the body and adjacent to the opening.
